(19) United States
(12) Patent Application Publication
(10) Pub. No.: US 2020/0017415 A1
(43) Pub. Date: Jan. 16, 2020

(54) HIGH STRENGTH POROUS MATERIAL

(71) Applicant: Arizona Board of Regents on Behalf of the University of Arizona, Tuscon, AZ (US)

(72) Inventors: Moe Momayez, Tucson, AZ (US); Krishna Muralidharan, Tucson, AZ (US); Doug Loy, Tucson, AZ (US); Yen Thi Kim Do, Tucson, AZ (US); Pratish Ramesh Rao, Tucson, AZ (US)

(21) Appl. No.: 16/510,854

(22) Filed: Jul. 12, 2019

Related U.S. Application Data
(60) Provisional application No. 62/697,889, filed on Jul. 13, 2018.

(51) Int. Cl. C04B 38/02; C04B 38/00; C04B 12/04; C04B 14/30; B28B 1/00

(52) U.S. Cl. CPC C04B 38/02; C04B 38/0067; C04B 12/04; C04B 2111/40; B28B 1/001; C04B 2201/50; C04B 14/30

(57) ABSTRACT

A lightweight porous material with increased strength and mechanical properties, the use and the preparation thereof.

### CROSS REFERENCE TO RELATED APPLICATIONS

This application claims the benefit of the filing date of Provisional Appl. No. 62/697,889, filed Jul. 13, 2018, the contents of which are hereby incorporated by reference in its entirety.

### STATEMENT OF FEDERALLY SPONSORED RESEARCH AND DEVELOPMENT

This invention was made with government support under National Institute for Occupational Safety and Health (NIOSH) Grant No. 200-2014-59953 awarded by the CDC. The government has certain rights in the invention.

### FIELD OF THE INVENTION

The field of the invention relates generally to a high strength porous material, the preparation, and the use thereof.

### BACKGROUND

Geopolymers are becoming increasingly used in construction materials as well as other purposes. Geopolymers have gained increased interest because of the ability to utilize hazardous materials such as fly ash and mine tailings. The current problem with geopolymers is that they tend to be strong but also brittle.

Geopolymer foams have been used in various applications such as the use in concrete including a sprayable concrete known as Shotcrete. They are also used for their insulating properties and fire-retardant nature in foam panels. The current downside to most geopolymers is they can be brittle in nature. One advantage of the invention is that overcomes this problem and involves strengthening the porous material, such as geopolymer, without leaving it brittle and also provides a high thermal resistance. Furthermore, the porous materials of the invention may be formulated to produce an extremely lightweight foam that can be sprayed or used as a 3D printing material. Consequently, the invention may be used for:
3D Printing
Fire retardant
Corrosion protection
Hot/cold insulation, including spray insulation
High speed brick manufacturing
Erosion control
Ground fall protection
Electrical heating
Reinforcing earthen dams
Pipe relining

Furthermore, some further advantages that the porous material disclosed herein provides includes:
High strength
Potentially reduced carbon emissions
Lightweight
Soundproofing
Thermal resistance (high)
Inexpensive
The aluminosilicate base of the geopolymer binding is important in bringing high temperature stability
Corrosion resistance

### SUMMARY

The inventors have discovered a novel high strength porous structural material that is lightweight and that may be sprayable.

Furthermore, the inventors have surprisingly discovered a relatively simple, low-cost and low energy technique to synthesize an aluminosilicate foam from silica and alumina powder by activating the slurry with an aqueous NaOH solution and incorporating it with appropriate amounts of surfactant and blowing agent.

It is to be understood that both the foregoing general description of the invention and the following detailed description are exemplary, and thus do not restrict the scope of the invention.

### BRIEF DESCRIPTION OF THE FIGURES

FIG. 1: NaOH activated aluminosilicate slurry (left) and slurry in PTFE petri dish for curing (right).

FIG. 2: Block representation of steps involved in preparation of control samples and geofoam.

FIG. 3: Pourbaix diagram showing speciation of pure Al₂O₃

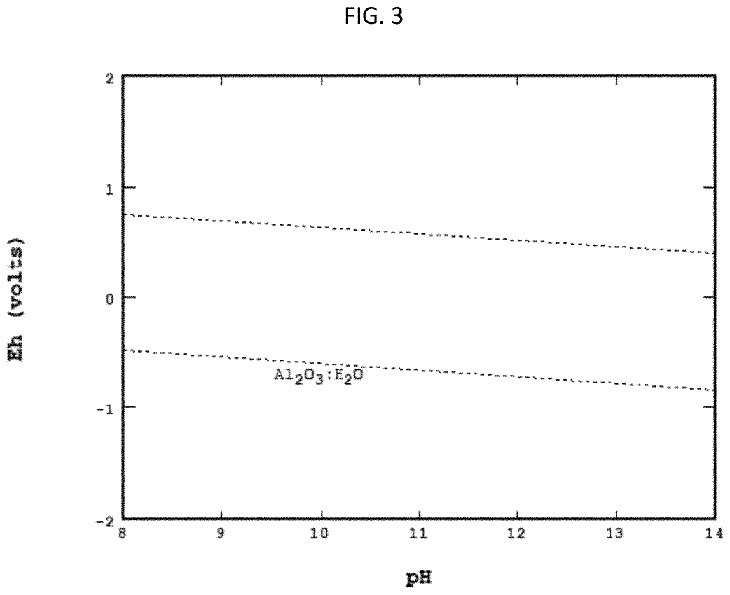

FIG. 4: Pourbaix diagram showing speciation of pure SiO₂

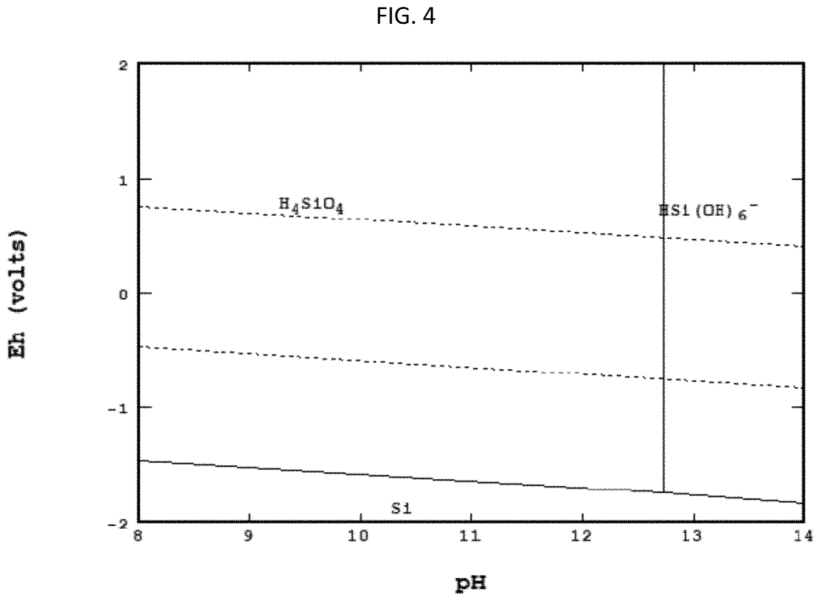

FIG. 5: Pourbaix diagram showing speciation of SiO₂ and Al₂O₃ (Si:Al=3:1) combined.

FIG. 6: SEM micrographs of alumina-silica physical blend (a) and (b) at 100× and 5000×; control samples (c) and (d) at 80× magnification.

FIG. 7: High resolution SEM images of NAS foam (sample 15) at two different resolutions

FIG. 8: EDS mapping to study elemental distribution.

FIG. 9: An FTIR spectra for: precursor materials and the control.

FIG. 10: An FTIR spectra for: foam materials and the control.

FIG. 11: XRD overlay of foam samples including precursor materials.

FIG. 12: ²⁹Si (left) and ²⁷Al (right) NMR spectra of precursor materials and alkali treated aluminosilicate (final product including foams).

FIG. 13: A schematic representation of: (a) Qₙ type coordination in aluminosilicate networks and (b) a possible explanation of peak broadening in NMR spectra for aluminosilicates.

FIG. 14: Sample evolution—untreated control (a), with stearic acid and hydrogen peroxide (b) and showing cross-section (c) to observe homogeneity.

FIG. 15: Sample evolution—(a) sample 15 (with stearic acid and hydrogen peroxide without sonication) and (b) sample 15 after 99 min. sonication to observe homogeneity.

FIG. 16: Performance to flame exposure of: control (top) and sample 15 (bottom) before and after 30 s of flame treatment.

FIG. 17. Exemplary method of preparing GeO Foam followed by Brazilian Test

FIG. 18: Results of Brazilian Disk tests for aluminosilicate composite versus aluminosilicate+GO composite, an exemplary embodiment of the invention.

FIG. 19: Applied Load vs Time for aluminosilicate composite versus aluminosilicate+GO composite

FIG. 20: Tensile Strengths and Density for aluminosilicate composite versus aluminosilicate+GO composite versus Portland Cement

FIG. 21: Chemical Structures of Graphene and Graphene Oxide

### DETAILED DESCRIPTION

### 1.0. Definitions

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated invention, and further applications of the principles of the invention as illustrated therein are herein contemplated as would normally occur to one skilled in the art to which the invention relates.

Unless defined otherwise, all technical and scientific terms used herein have the same meaning as commonly understood by one of ordinary skill in the art to which this invention pertains.

For the purpose of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used).

The use of “or” means “and/or” unless stated otherwise.

The use of “a” or “an” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of.”

As used herein, the term “about” refers to a ±10% variation from the nominal value. It is to be understood that such a variation is always included in any given value provided herein, whether or not it is specifically referred to.

The term “chemically modified graphene (CMG)” refers to graphene that has been chemically functionalized with for one or more chemical groups. Chemical groups that may be used in the CMG further described herein includes carbony [>C=O], —COOH, —OH, —O— (e.g., epoxy), C—O, and Na. The term “Na”, as used in reference to CMGs is representative of a class of alkali and alkali earth metals. It can crosslink GO sheets as well as serve as cations for charge balance in the geopolymer matrix. For example, the term “Na” maybe Na, Ca, K, Mg as well as Fe and Cu.

In some embodiments, CMG may be graphene oxide (GO), reduced graphene oxide (rGO), or cation crosslinked GO.

CMGs provide high modulus, high strength, chemical bonding with the aluminosilicate backbone.

One aspect of the invention encompasses a lightweight sprayable geopolymer foam comprising a mixture of CMG and one or more transition metal oxides. As an example, mine tailings, fly ash, or volcanic ash can be used as a material source which contain transition metal oxides such as alumina silicate. This material can be applied to various applications including hot/cold insulation, mining walls, fire retardant, corrosion protection and many more.

In some embodiments the porous material may include Si and Al in a ratio from 1 to 4.2 (by mass). Si:Al ratio may also be present in a ratio of 3:1 (by moles of silicon and aluminum) or e.g., 30 g SiO₂, 8.5 g Al₂O₃=3.5:1 (by mass).

One aspect of the invention pertains to the ratio of Si:Al present as follows:
Fly ash—(56%, 29%)
Metakaolin—(53%, 44%)
GGBFS (ground granulated blast furnace slag)—(33%, 18%)
Portland cement—(21%, 5%)

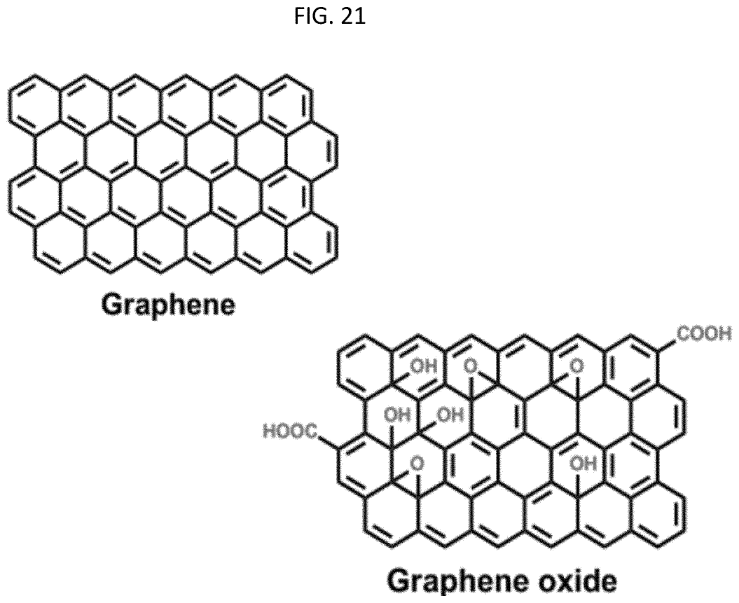

Another aspect of the invention encompasses a composition or material comprising graphene oxide and one or more aluminosilicates (which may be referred to as AS-GO composite). Graphene Oxide (GO) (see FIG. 21) is a 2-D material with remarkable mechanical, electronic and optical properties. It may be prepared from graphite using the Hummer's method. AluminoSilicates (AS) are primary constituents in mine-tailings and fly-ash. AS-GO composites represent low-cost alternatives for Portland cement-based systems. These composites have various advantageous uses including conducive for foams, thermal insulation applications (mines, buildings). Furthermore, AS-GO composites are novel light-weight structural materials with enhanced strength.

Another aspect of the invention encompasses use of the materials disclosed herein for 3D Printing. On aspect of the invention pertains to a 3D printing material wherein said 3D printing material comprises a porous material of the invention claim 1, sodium perborate, and water. For example, the 3D material may comprise about 2 to 10 mL of 2 wt. % in DI water.

Another aspect of the invention encompasses use of the materials disclosed herein as a fire retardant, or as a component of a fire retardant.

Another aspect of the invention encompasses use of the materials disclosed herein for corrosion protection.

Another aspect of the invention encompasses use of the materials disclosed herein for insulation, for example, sound insulation, hot/cold insulation (e.g., (in mines, commercial, or residential buildings), including spray insulation, etc.

Another aspect of the invention encompasses use of the materials disclosed herein as for high speed brick manufacturing.

Another aspect of the invention encompasses use of the materials disclosed herein as for erosion control.

Another aspect of the invention encompasses use of the materials disclosed herein as for ground fall protection.

Another aspect of the invention encompasses use of the materials disclosed herein as for electrical heating.

Another aspect of the invention encompasses use of the materials disclosed herein as for reinforcing earthen dams.

Another aspect of the invention encompasses use of the materials disclosed herein as for lining pipes, for example, pipe relining.

Another aspect of the invention encompasses use of the materials disclosed herein as for corrosion protection.

Another aspect of the invention encompasses use of the materials disclosed herein to provide underground support system.

Another aspect of the invention encompasses use of the materials disclosed herein for the production of precast building blocks. In some embodiments, the materials disclosed herein may be used for rapid production of precast building blocks.

Another aspect of the invention encompasses use of the materials disclosed herein for the manufacture of concrete. In some embodiments, the materials disclosed herein may be used for the manufacture of shotcrete.

Another aspect of the invention pertains to a geopolymer foam known as GeO foams which are reinforced with CMG and that is capable of being applied through a spray technique. This geopolymer foam relies on the incorporation of transition metal oxides such as alumina silicate or zirconia. Fly ash, mine tailings or volcanic ash can all be used as a material source because they contain transition metal oxides. This invention includes a less than 1% weight addition of CMG which increases the mechanical properties of the geopolymer foam, resulting in a stronger and less brittle geopolymer. Additionally, how the foam is produced, and the foaming agent used can result in a lightweight foam that can be sprayed on or even pushed out of a small tip for applications such as 3D printing.

Solid foaming agents, hydrogen peroxide, and surfactants may be used to obtain a lightweight foam. The amount of foaming agent used, results in the desired density of the foam for differing applications. Surfactants may include saturated fatty acids {CH₃(CH₂)ₙCOOH} with varying ‘n’ that indicates varying carbon backbone length, e.g., lauric acid 99% (C₁₂H₂₄O₂), palmitic acid (C₁₆H₃₂O₂), stearic acid (C₁₈H₃₆O₂), cerotic acid (C₂₆H₅₂O₂), etc. “n” maybe 12 to 26.

### AS-GO Composite

### AS Precursor

The inventors have discovered a simple preparation technique of low density porous foams (e.g., ˜0.22 g/cc, pore size ˜350 μm) from pristine silica and alumina powder. These AS foams may be prepared by activating aluminosilicate slurry with alkali and then cured in a conventional oven at elevated temperatures to promote polycondensation. These foams may be prepared by varying the blowing agent and surfactant concentrations to control porosity and product character (see examples 1-2 below).

Graphene Oxide (GO), an exemplary CMG, is a 2-D material with remarkable mechanical, electronic and optical properties. It may be prepared from graphene (see using the Hummer' s method. See e.g., Chen, J., et al., An improved Hummers method for eco-friendly synthesis of graphene oxide. Carbon, 64, 225-229 (2013). Traditionally, GO is used in material for high-strength, light-weight composites.

Aluminosilicates (AS) are primary constituents in mine-tailings and fly-ash.

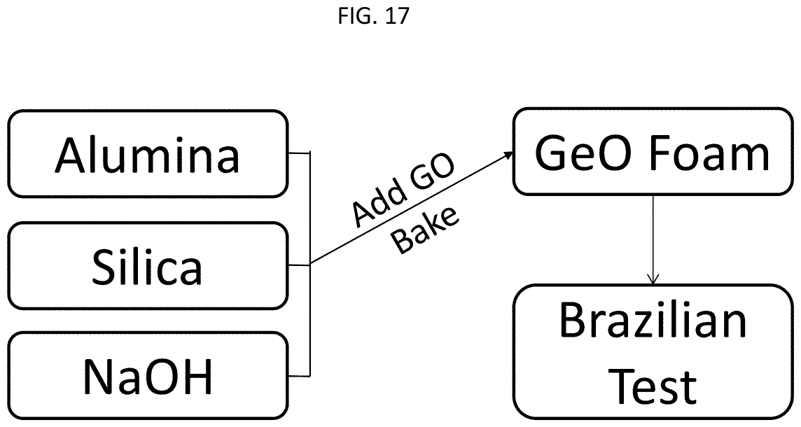

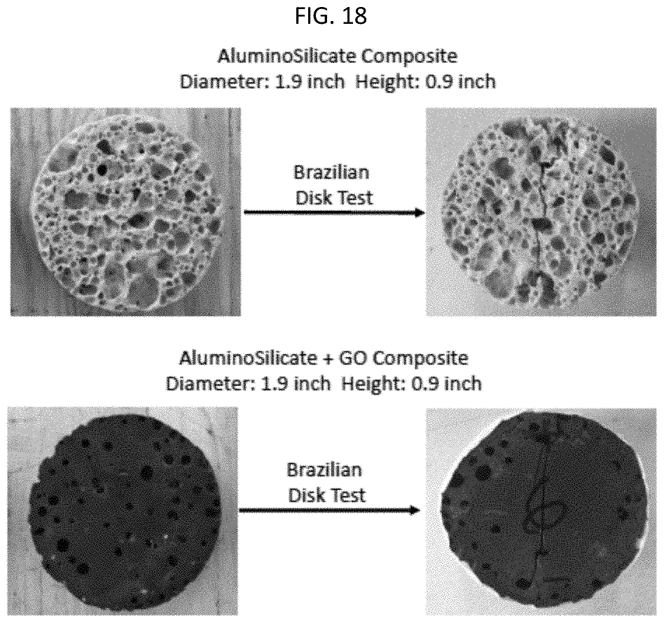

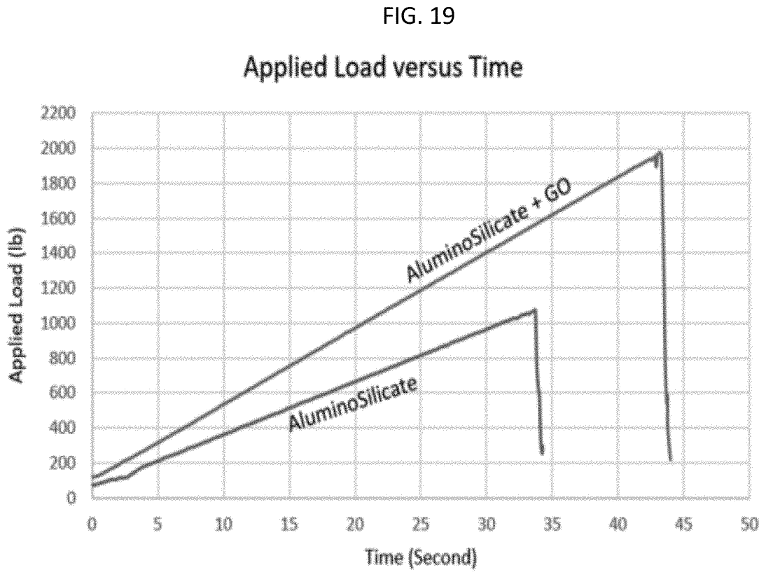

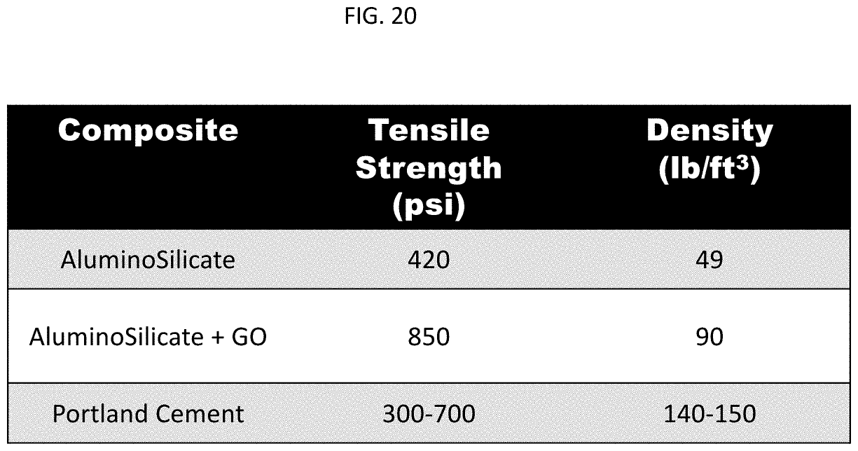

The inventors have surprisingly found that porous materials comprising a mixture of two of components chosen from earth abundant minerals, oxides, silicates, and chemically modified graphene (CMG) (e.g., AS-GO composites) represent low-cost alternatives for Portland cement-based systems (see FIGS. 17-20). The porous material may further comprise blowing agents and/or surfactants. These porous materials (e.g., AS-GO composites) are novel light-weight structural materials with enhanced strength, an improvement over traditional structural materials such as Portland cement. One aspect of the invention pertains to porous materials comprising a mixture of two of components chosen from earth abundant minerals, oxides, silicates, and chemically modified graphene (CMG) (e.g., AS-GO composites). These composites may be used in conducive for foams. Furthermore, these AS-GO composites may be used thermal insulation applications (mines, buildings).

AS-GO composites, an exemplary embodiment of the invention, may be prepared as illustrated in FIG. 17. See e.g., Example 3 described herein.

One aspect of the invention pertains to a porous material comprising a mixture of two or more components chosen from earth abundant minerals, oxides (e.g., alumina, transition metal oxides such as titanium oxide, iron oxide (Fe²⁺ or, Fe³⁺ ), Fe₃O₄, zirconia, hafnia, vanadium oxide (II-V), ruthenium oxide, copper oxide), silicates (e.g., calcium silicates, magnesium silicates, aluminosilicates), and chemically modified graphene (CMG) (e.g., graphene oxide). The porous material may further comprise one or more blowing agents (e.g., H₂O₂, N₂, NH₃, CO₂), and/or one or more surfactants (e.g., stearic acid, CTAB, SDS and similar surfactants). In some embodiments, the porous materials comprise any or some of the foregoing compounds/components.

In another aspect of the invention pertains to a porous material comprising chemically modified graphene (CMG) (e.g., graphene oxide) and optionally a mixture of one or more components chosen from earth abundant minerals, oxides (e.g., alumina, transition metal oxides such as titanium oxide, iron oxide (Fe²⁺ or, Fe³⁺), Fe₃O₄, zirconia, hafnia, vanadium oxide (II-V), ruthenium oxide, copper oxide), and silicates (e.g., calcium silicates, magnesium silicates, aluminosilicates). The porous material may further comprise one or more blowing agents (e.g., H₂O₂, N₂, NH₃, CO₂), and/or one or more surfactants (e.g., stearic acid, CTAB, SDS and similar surfactants). In some embodiments, the porous materials comprise any or some of the foregoing compounds/components.

In further aspect of the invention pertains to a porous material comprising chemically modified graphene (CMG) (e.g., graphene oxide) and optionally a mixture of one or more components chosen from earth abundant minerals, oxides (e.g., alumina, transition metal oxides such as titanium oxide, iron oxide (Fe²⁺ or, Fe³⁺), Fe₃O₄, zirconia, hafnia, vanadium oxide (II-V), ruthenium oxide, copper oxide), and silicates (e.g., calcium silicates, magnesium silicates, aluminosilicates). The porous material may further comprise one or more blowing agents (e.g., H₂O₂, N₂, NH₃, CO₂), and/or one or more surfactants (e.g., stearic acid, CTAB, SDS and similar surfactants). In some embodiments, the porous materials comprise any or some of the foregoing compounds/components.

One further aspect of the invention pertains to a porous material comprising one or more aluminosilicates, and optionally a mixture of one or more components chosen from earth abundant minerals, silicates, and oxides (e.g., alumina, transition metal oxides such as titanium oxide, iron oxide (Fe²⁺ or, Fe³⁺), Fe₃O₄, zirconia, hafnia, vanadium oxide (II-V), ruthenium oxide, copper oxide). In some embodiments, the Si:Al ratio of said aluminosilicates is in ratio of 3:1 ratio (by mole).

Another aspect of the invention pertains to a porous material comprising a mixture of one or more calcium silicates and one or more aluminosilicates, and optionally a mixture of one or more components chosen from earth abundant minerals, and oxides (e.g., alumina, transition metal oxides such as titanium oxide, iron oxide (Fe²⁺ or, Fe³⁺), Fe₃O₄, zirconia, hafnia, vanadium oxide (II-V), ruthenium oxide, copper oxide). The porous material may comprise 1 to 3 moles of calcium silicate. 1 mole calcium silicate will provide 2 moles of Ca+ ions.

The porous material may further comprise one or more blowing agents (e.g., H₂O₂, N₂, NH₃, CO₂), and/or one or more surfactants (e.g., stearic acid, CTAB, SDS and similar surfactants). This porous material comprising a mixture of one or more calcium silicates and one or more aluminosilicates may be used to for insulation by spraying the compound on the rocks in underground mines, or in insulation in built environments. Currently, air conditioning and ventilation is used to mitigate the concerns from heat when working underground. This method can become very expensive.

The invention further encompasses a class of inorganic-organic polymer composites based on calcium silicate and aluminosilicate precursors, for thermally insulating underground excavations from geothermal heat as well as built environments from the sun on hot days is proposed. The aluminosilicate precursor is either derived from mine tailings, fly-ash or blast furnace slags or from pure silica and alumina constituents, while the calcium silicate precursor is obtained from calcium carbonate and silica. Subsequently both systems are hydrolytically activated by the simultaneous addition of alkali containing materials (sodium hydroxide, sodium silicate, sodium bicarbonate) and water. The organic polymer, which is an elastomeric thermoset may be derived from a dissocyanate (—N═C═O) and a polyol (multiple -OH groups) mixed in 1:1 volume and cured at 150 deg. F. high pressure to form a polyurethane. The porosity of the inorganic constituent may be controlled by varying synthesis conditions allowing the ability to control its thermal conductivity to be less than 0.01 W/mK. The polyurethene constituent is characterized by similar low thermal conducting properties as well as high mechanical strength and corrosion resistance. The composite may be installed by spraying a layer of the inorganic constituent (aluminosilicate or calcium silicate); the thickness of this layer can be varied depending on each application—on the walls, ceiling, and floor. When protection from natural elements and/or corrosion, and/or impact is required, additionally two layers (one on the inside and one on the outside of the thermal insulating material) of the elastomeric thermosetting coating is applied.

In some embodiments, the invention pertains to a porous material comprising two primary oxides and optionally, comprising one or more components chosen from earth abundant minerals, and chemically modified graphene (CMG) (e.g., graphene oxide). These primary oxides may be chosen from alumina (Al₂O₃), transition metal oxides such as titanium oxide, iron oxide (Fe²⁺ or, Fe³⁺), Fe₃O₄, zirconia, hafnia, vanadium oxide (II-V), ruthenium oxide, copper oxide, silicates (e.g., calcium silicates, magnesium silicates, aluminosilicates). The resulting porous material may further comprise one or more blowing agents (e.g., H₂O₂, N₂, NH₃, CO₂), and/or one or more surfactants (e.g., stearic acid, CTAB, SDS and similar surfactants). In further embodiments, the porous material comprises the primary oxides (in an amount of about 20/80 wt. % to about 80/20 wt. %), and about 1 wt. % or less of surfactants, and blowing agents.

In some embodiments, the invention pertains to a porous material comprising two primary oxides and optionally, comprising one or more components chosen from earth abundant minerals, and chemically modified graphene (CMG) (e.g., graphene oxide). These primary oxides may be chosen from alumina (Al₂O₃), transition metal oxides such as titanium oxide, iron oxide (Fe²⁺ or, Fe³⁺), Fe₃O₄, zirconia, hafnia, vanadium oxide (II-V), ruthenium oxide, copper oxide, silicates (e.g., calcium silicates, magnesium silicates, aluminosilicates). The resulting porous material may further comprise one or more blowing agents (e.g., H₂O₂, N₂, NH₃, CO₂), and/or one or more surfactants (e.g., stearic acid, CTAB, SDS and similar surfactants). In further embodiments, the porous material comprises the primary oxides (in an amount of about 20/80 wt. % to about 80/20 wt. %), and about 1 wt. % or less of surfactants, and blowing agents.

In further embodiments, the invention encompasses a porous material comprising calcium silicate and aluminosilicate, and optionally, further comprising earth abundant minerals, one or more blowing agents (e.g., H₂O₂, N₂, NH₃, CO₂), and/or one or more surfactants (e.g., stearic acid, CTAB, SDS and similar surfactants).

In some embodiments, the invention pertains to a porous material comprising two primary oxides and chemically modified graphene (CMG) (e.g., graphene oxide), and optionally, comprising one or more earth abundant minerals,. These primary oxides may be chosen from alumina (Al₂O₃), transition metal oxides such as titanium oxide, iron oxide (Fe²⁺ or, Fe³⁺), Fe₃O₄, zirconia, hafnia, vanadium oxide (II-V), ruthenium oxide, copper oxide, silicates (e.g., calcium silicates, magnesium silicates, aluminosilicates). The resulting porous material may further comprise one or more blowing agents (e.g., H₂O₂, N₂, NH₃, CO₂), and/or one or more surfactants (e.g., stearic acid, CTAB, SDS and similar surfactants). In further embodiments, the porous material comprises the primary oxides (in an amount of about 20/80 wt. % to about 80/20 wt. %), and about 1 wt. % or less of surfactants, and blowing agents.

As used herein “primary oxides” refers to a porous material wherein the primary or main components are two oxides. These primary oxides may be chosen from alumina, transition metal oxides (such as titanium oxide, iron oxide (Fe²⁺ or, Fe³⁺), Fe₃O₄, zirconia, hafnia, vanadium oxide (II-V), ruthenium oxide, copper oxide), and silicates (e.g., calcium silicates, magnesium silicates, aluminosilicates).

In some embodiments, the alumina used in the present invention is a 99% fine powder with average particle sizes of 18.2 μm. The alumina present in the porous mixture of the invention may be present with average particle sizes of less than 30 μm.

In some embodiments, the silicon (IV) oxide (SiO₂) 99.5% with ˜96% of particle sizes less than 10 μm from Alfa Aesar.

In some embodiments, the CMG may be present in the porous material in an amount of about 1 wt % or less.

In some embodiments, the CMG may be present in the porous material in an amount of about 1 wt. % to less than about 0.1 wt. %.

In some embodiments, the CMG may be present in the porous material in an amount of about 1 wt. % to about 0.1 wt. %.

In some embodiments, the CMG may be present in the porous material in an amount of about 1 wt. % to about 0.5 wt. %.

In some embodiments, the CMG may be present in the porous material in an amount of about 0.5 wt. % to about 0.1 wt. %.

In some embodiments, the CMG may be present in the porous material in an amount of about 1 wt. % to less than about 0.1 wt. %.

In some embodiments, the CMG may be present in the porous material in an amount of about 0.2 wt. % to about 0.1 wt. %.

In some embodiments, the CMG may be present in the porous material in an amount of about 1 wt. %.

In some embodiments, the CMG may be present in the porous material in an amount of about 0.9 wt. %.

In some embodiments, the CMG may be present in the porous material in an amount of about 0.8 wt. %.

In some embodiments, the CMG may be present in the porous material in an amount of about 0.7 wt. %.

In some embodiments, the CMG may be present in the porous material in an amount of about 0.6 wt. %.

In some embodiments, the CMG may be present in the porous material in an amount of about 0.5 wt. %.

In some embodiments, the CMG may be present in the porous material in an amount of about 0.4 wt. %.

In some embodiments, the CMG may be present in the porous material in an amount of about 0.3 wt. %.

In some embodiments, the CMG may be present in the porous material in an amount of about 0.2 wt. %.

In some embodiments, the CMG may be present in the porous material in an amount of about 0.1 wt. %.

In some embodiments, the CMG may be present in the porous material in an amount of less than about 0.1 wt. %.

In some embodiments, the CMG may be present in the porous material in an amount of about 0.05 wt. %.

In some embodiments, the CMG may be present in the porous material in an amount of about 0.02 wt. %.

In some embodiments, the CMG may be present in the porous material in an amount of about 0.01 wt. %.

In some embodiments, the porous material further comprises of by-product of mining and manufacturing industries (such as mine tailings, fly ash, slags, etc.), natural materials (e.g., volcanic ash, rice husk, red mud.)

Fly ash, mine tailings and/or volcanic ash maybe all be used as a material source because they contain transition metal oxides.

A method of preparing a porous material comprising of low-temperature processing steps, that include (i) physical mixing of powders, (ii) chemical treatment, (iii) direct foaming, (iv) thermal and/or photo curing; other methods include 3-D printing from pastes and gels made from aqueous and non-aqueous blends of oxide powders.

The porous material is a lightweight, sprayable geopolymer foam with increased strength and mechanical properties. In some embodiments, the porous material is lightweight, i.e., the porous material has a density of about 0.01 g/cc to about 5 g/cc. For example, aluminosilicate foams reinforced by chemically modified graphene demonstrate twice the mechanical modulus, compressive strength as that of cement, though the density of the foams are up to ¼ that of cement which make it suitable for applications requiring mechanical strength.

Aluminosilicate foams (without CMG) are suitable for applications where thermal conductivity is crucial. Aluminosilicate foams (without CMG) may be used for:
Thermal/acoustic insulation
Solid state battery materials
Spill/chemical adsorbents
Metal alloy filtration

In some embodiments, the porous material is lightweight, i.e., the porous material has a density of about 0.01 g/cc to about 5 g/cc.

In further embodiments, the porous material is lightweight, i.e., the porous material has a density of about 0.1 g/cc to about 5 g/cc.

In some embodiments, the porous material is lightweight, i.e., the porous material has a density of about 0.01 g/cc to about 0.1 g/cc.

In further embodiments, the porous material is lightweight, i.e., the porous material has a density of about 1 g/cc to about 5 g/cc.

In further embodiments, the porous material is lightweight, i.e., the porous material has a density of about 0.1 g/cc to about 2 g/cc.

In further embodiments, the porous material is lightweight, i.e., the porous material has a density of about 0.1 g/cc to about 1 g/cc.

In further embodiments, the porous material is lightweight, i.e., the porous material has a density of about 0.01 g/cc.

In further embodiments, the porous material is lightweight, i.e., the porous material has a density of about 0.1 g/cc.

In further embodiments, the porous material is lightweight, i.e., the porous material has a density of about 0.5 g/cc.

In further embodiments, the porous material is lightweight, i.e., the porous material has a density of about 1 g/cc.

In further embodiments, the porous material is lightweight, i.e., the porous material has a density of about 3 g/cc.

In further embodiments, the porous material is lightweight, i.e., the porous material has a density of about 5 g/cc.

One aspect of the invention is a sprayable porous material. In some embodiments, the porous material comprises blowing agents. For example, aluminosilicate foam has a density that is one to two orders of magnitude lighter than shotcrete (approximately 2.3 g/cc) and significantly less viscous than shotcrete. The foam can be easily sprayed at low velocities for rapid installation in large scale industrial applications.

Another aspect of the invention pertains to shotcrete comprising porous material.

Another aspect of the invention pertains to concrete comprising porous material.

Another aspect of the invention pertains to 3D printing material comprising porous material.

Another aspect of the invention pertains to an insulating material comprising porous material. In some embodiments, the invention encompasses a method of insulating a surface comprising applying the insulating material to said surface.

Another aspect of the invention pertains to an anti-corrosion material comprising said a porous material of the invention. In some embodiments, the invention encompasses a method of protecting a surface from corrosion comprising applying the anti-corrosion material to said surface. In further embodiments, the anti-corrosion material comprises a porous material according to the invention and one or more components chosen from carbon nanotubes, zinc phosphates, graphene oxide, and epoxy.

The term “porous material” is used in the present application to refer to a porous material according to the invention.

### EXAMPLE

### Example 1

### Preparation of Aluminosilicate Foams from Silica and Alumina Precursors

### Materials

Quartz or silicon (IV) oxide (SiO₂), 13024 from lot #N15CO13 of size<10 microns and >99.5% purity and alpha-corundum or alumina (Al₂O₃), 12553 from lot #Q06C050>99% purity was used as silicon and aluminum sources as received from Alfa Aesar. Sodium hydroxide (NaOH) pellets A16037, lot #10198909 as obtained from Alfa Aesar was used to prepare alkali solutions. Ethyl alcohol (C₂H₅OH) 200 proof, a solvent, batch #30296HK of >99.5% purity was supplied by Sigma Aldrich. Food grade Stearic acid (CH₃(CH₂)₁₆COOH) was ordered from Amazon.

### Instrumentation

A mass balance Tree model—HRB 3002 with d=0.01 g was used for weighing chemicals. The alkali dissolution and stirring were performed on a Spin

Master Model 4803 stirrer with hot plate while other solutions were stirred on a Corning Model PC-420 stirrer with hot plate. The samples were cured on a Despatch convection oven with heating capability up to 275° C.

### Methods

### Step-by-Step Approach of Sample Preparation

The following section aims at demonstrating systematic procedure followed in preparation of test specimens.

Preparation of alkali solution in a clean glass beaker of 400 mL capacity, 40 g NaOH pellets was dissolved in 100 mL deionized water (DIW) on a stirrer with a 1 in. Teflon magnetic stir bar to produce a 10 M alkali solution. Since the dissolution process is exothermic, the solution was allowed to cool down to ambient temperature. A series of 3 different alkali solutions of strengths 5, 10 and 15 M was prepared.

Preparation of stearic acid (surfactant) solution 100 mL of ethanol was poured into a clean glass beaker of 250 mL capacity. 20 g of stearic acid powder was added to the beaker and stirred on a hot plate at 110° C. for 20 min. As boiling point of ethanol is 78° C., care was taken to avoid solvent evaporation (by maintaining solution temperature <boiling point) thus preventing any changes in initial concentration.

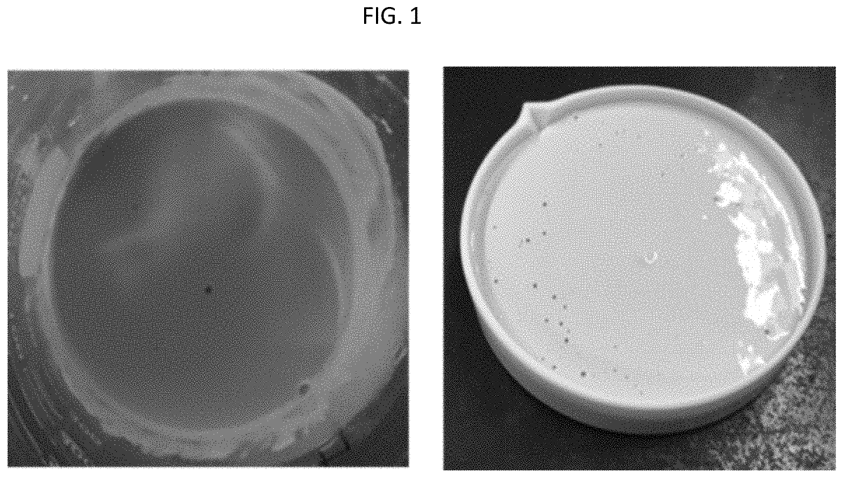

In another glass beaker of 400 mL capacity, 60 g of SiO₂ (1 mole Si) was measured along with 17 g Al₂O₃ (0.33 moles Al) to ensure Si:Al ratio of 3:1. To this mix, 33 mL of 10 M NaOH solution was added (to maintain a Na:Al ratio of 1:1 for charge balance). The mixture was first stirred manually with a spatula followed by vigorous stirring for 3 min. using a whisk for homogenization. See FIG. 1.

### Sonication of Al-Si Slurry

Once the slurry was manually stirred and homogenized, it was sonicated in a Branson 5510 ultrasonic bath sonicator for 99 min. aimed to enhancing dispersion quality. Addition of blowing agent and surfactant was done post-sonication to prevent any premature decomposition of peroxide due to any temperature rise in slurry.

### Specimen Preparation

The Al-Si slurry once homogenized, was poured onto a low form Teflon petri dish (2 in. diameter and 0.5 in. wall height) and was cured at 100° C. for 72 h to produce ‘control’ samples. Further modification on the slurry, such as addition of hydrogen peroxide and stearic acid solution along with sonication was accordingly performed to generate well distributed porosity in samples classified as ‘geofoams’. Different sample in the series and their respective chemical compositions are listed in table in the appendix as ‘sample key’.

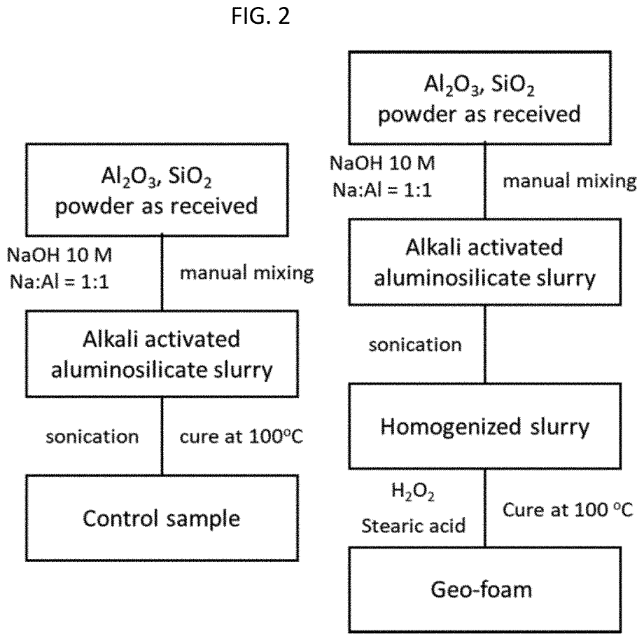

The FIG. 2 is a block representation of the experimental protocol followed in sample preparation.

### Analysis/Characterization

### pH Test of Al-Si Slurry

The basic pH due to addition of alkali solution to the Al-Si mix was measured with a pH strip having measurability in the range 0-14. The pH variation with water evaporation over time was also tracked with the help of pH strips.

### Speciation

A high pH (of 14) of aluminosilicate slurry involved complex speciation that was necessary to be established in order to understand reaction evolution. An E vs pH plot, also known as the Pourbaix diagram, was plotted for pure SiO₂, Al₂O₃ as well as combined silica-alumina system (Si:Al=3:1).

### Scanning Electron Microscopy (SEM)

High resolution imaging was performed on a FEI Inspec-S type SEM instrument and comparison was made on starting materials as well as finished specimens for analyzing changes in microstructure. Samples pieces were mounted onto a Ted-Pella sample holder adhered with the help of a double-sided carbon tape. Imaging was performed on several random areas of the section.

### Fourier Transform Infrared Spectroscopy (FTIR)

FTIR spectra were obtained on a Nicolet 4700 FTIR spectrometer, equipped with an IR source, KBr beam splitter and a DTGS KBr detector. The samples were first ground in a mortar with a pestle and mixed at 2% wt. concentration with fine KBR powder. For each sample 4 scans were recorded with a resolution of 4 cm−1.

### X-ray diffraction (XRD)

The measurements were performed on PANalytical X'pert Pro MPD diffractometer equipped with a programmable incident beam slit (set to 1°), and an X'Celerator detector. The X-ray radiation used was Ni-filtered Cu Kα type with λ=1.5418 Å. Measurements were made in the bisecting geometry for 2θ ranging from 10 to 90° at a rate of 0.06 o/s. Diffraction pat- terns were analyzed using the PANalytical High Score software and compared with existing patterns in the ICDD database. The raw data was plotted in Excel.

### Nuclear Magnetic Resonance (NMR)

The NMR spectra was obtained from Bruker Avance III HD 400 MHz spectrometer, with a 3.2 mm MAS BB/1 H probe. For the 29Si run, the acquisition time was 60 ms with 256 scans whereas for the 27Al it was 50 ms with 512 scans.

### Porosity and Density Measurement

A NextEngine 3D scanner was used to map sample surfaces to measure volume via generation of a finite element mesh. From the ratio of sample weight to its scanned volume, density was determined. Additionally, sample dimensions were also measured with vernier calipers and density was determined via conventional mass to volume ratio.

### Flame Retardance Test

The flame endurance characteristic was tested by exposing the samples to the orange part of the flame, for a period of 30 s, from a butane lighter having an approximate temperature of about 800 to 1000° C.

### Results and Discussion Section

### pH test on Al-Si Slurry

The pH strips indicated that the Al-Si slurry with 5, 10 and 15 M NaOH, were all extremely basic with a pH of 14 (maximum measurable on the strip). Furthermore, on evaporation, after 15 min. intervals for first 45 min. of evaporation, the pH strip indicated a value of 14 which is the maximum measurable. A thorough study on pH variation with water evaporation is essential since it will be useful in understanding speciation which will further explain the reaction mechanism and bonding characteristics in the final product.

### Optimization of Si:Al ratio and water content

Of the 3 ratios of Si:Al of 1:1, 2:1 and 3:1 that were made, the 3:1 ratio was found to have optimum curing in 72 h as well as mechanical integrity. With respect to ease of stirring and homogenization, the water content in samples (with only stearic acid added) was maintained at 1:3 to solids (mass of NaOH, alumina and silica) by weight i.e. water:solids was 1:3 by weight. However, when blowing agent and surfactant were both added to the slurry, it was found ideal to maintain the water:solids ratio at 1:2 for reasons related to obtaining homogenous lump free slurry.

### Speciation

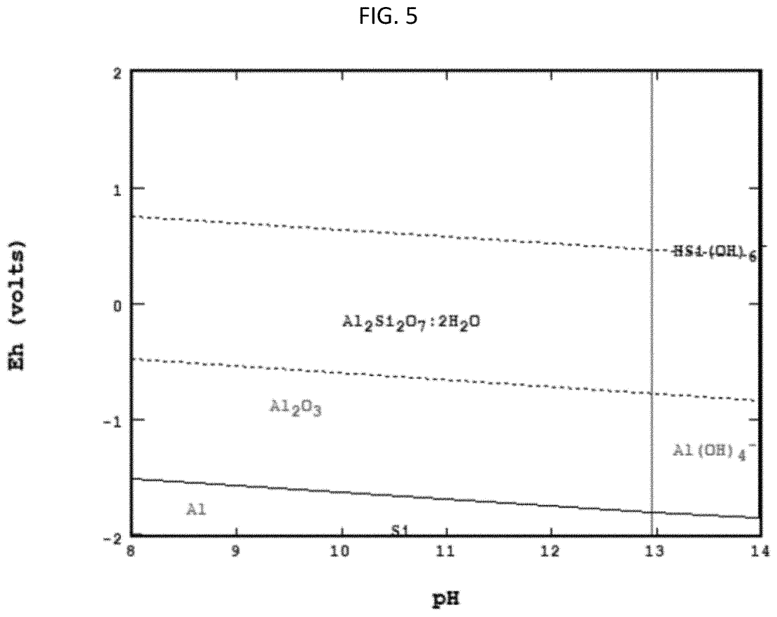

The FIG. 5, which represents the E-pH for aluminosilicate over a range of pH's indicates existence of interesting species in the system. It can be seen that formation of aluminosilicate, Al₂Si₂O₇,2H₂O is dominated in near neutral to a pH 13 regime. This indicates that formation of Kaolinite can occur in the pH range 8 to 13. The other alumina and silica species, namely HSi(OH)₆—and Al(OH)₄—can occur at very OH—ion concentrations.

### SEM/EDS

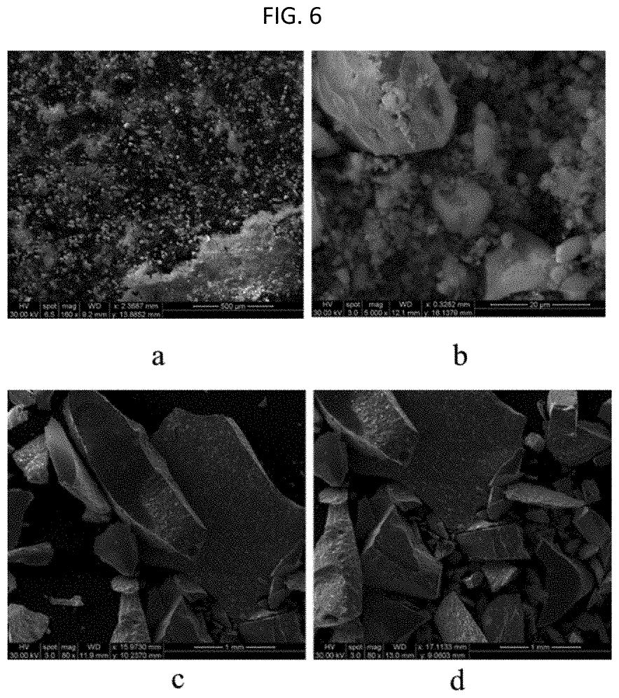

FIG. 6 shows the SEM micrographs of the unreacted Al-Si blend (a and b) in powder form at 100× and 5000× magnification respectively. Some areas appeared agglomerated and this may be attributed to static charges holding the particles together. FIGS. 6c and 6d, show different regions of the control specimen at 80×. There is considerable evidence of Al-Si interaction due to the strongly alkaline NaOH solution observed by radical changes in appearance.

Images at higher magnifications of control sample did not reveal additional valuable information and hence not included.

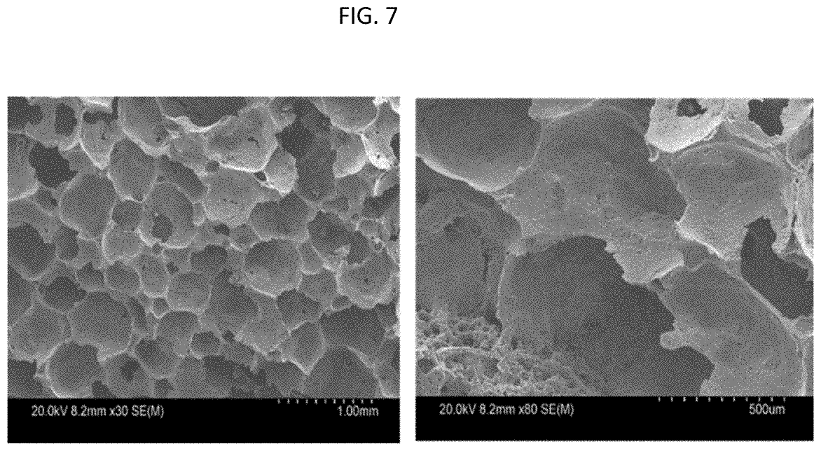

The FIG. 7 shows high resolution SEM images of the foam. It is evident that the foam is of closed cell type as well as near spherical in geometry which reveal information on the bubble morphology post foaming.

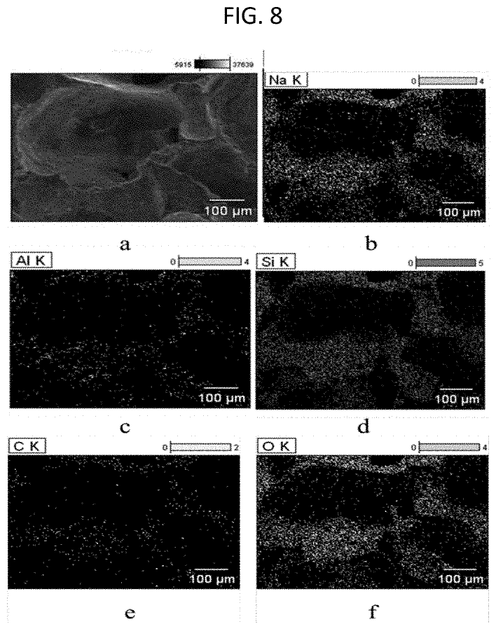

Additionally, the EDS maps as in FIG. 8, of various elements involved in the structure, show homogenous distribution over the entire sample. These maps present strong evidence that phase segregation did not occur during the condensation reaction

### FTI

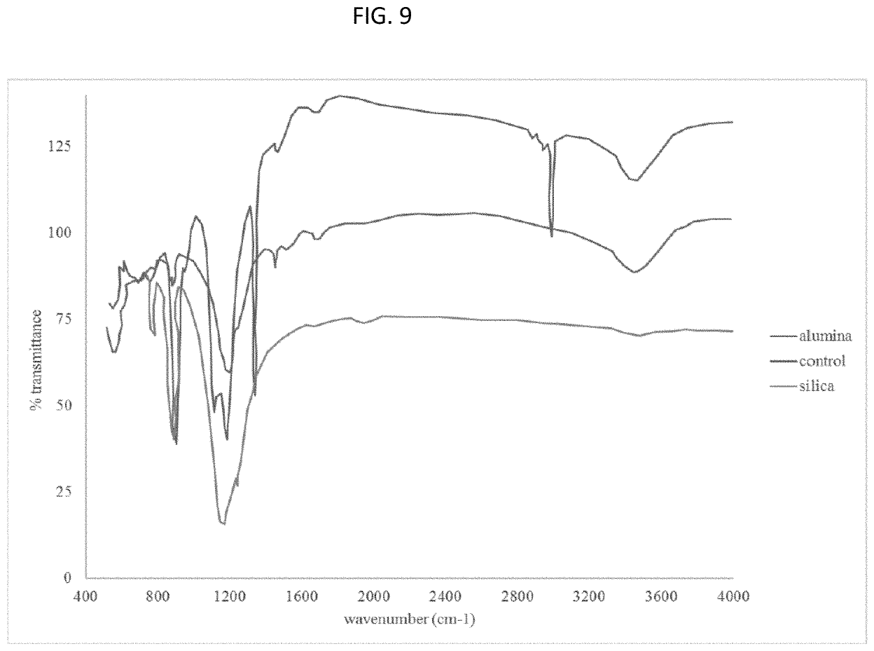

A prominent feature of aluminosilicate frameworks is their TO₄ (T is Al, Si) units connected by bridging oxygens (BO)₇. As seen in FIG. 9, the spectra of silica, alumina as well as control show peaks at ˜470, 700 and 1100 cm−1 which are attributed to the internal vibrations of the T-O-T bridge pertaining to rocking, bending and stretching respectively7. A band at ˜800 cm−1 in alumina along with weak ones at 670 and 550 cm⁻¹ indicate presence of Al as AlO₄, AlO₅ and AlO₆ respectively. A peak at ˜520 cm⁻¹ in the control sample is due to the Si—O—Al (octahedral Al) bending vibrations8 indicating replacement of Si by Al in the TO4 tetrahedra. The presence of water (residual/atmospheric) is confirmed from peaks at ˜1630 and 3450 cm−1.

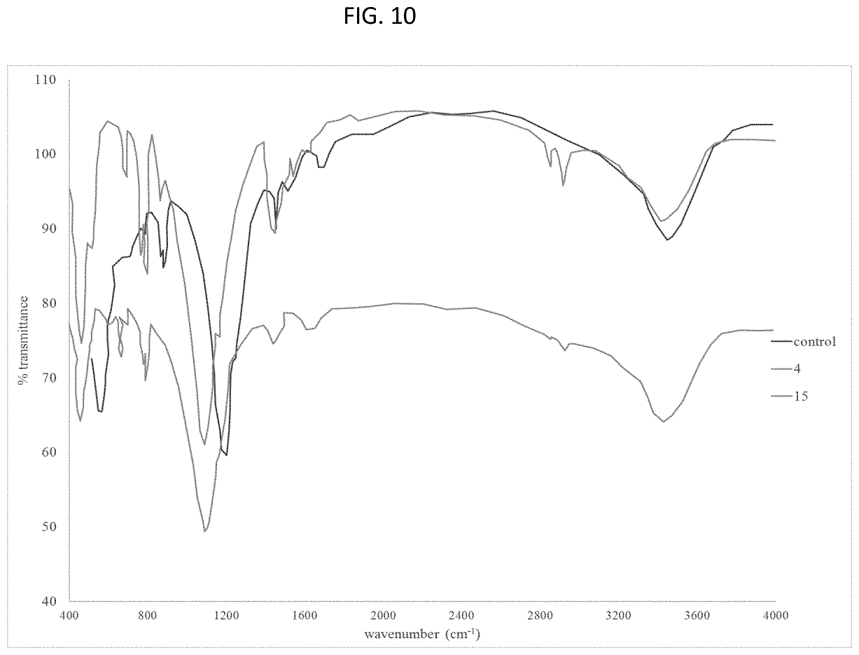

In FIG. 10, all 3 samples namely control, 4 and 15 show strong bands at ˜470 cm⁻¹ corresponding to Si—O—Al flex vibrations9. The strong band at 520 cm−1 in sample 4 is diminished in sample 15 indicating the dominance of Al in tetrahedral coordination in the latter 2 samples9.

### XRD

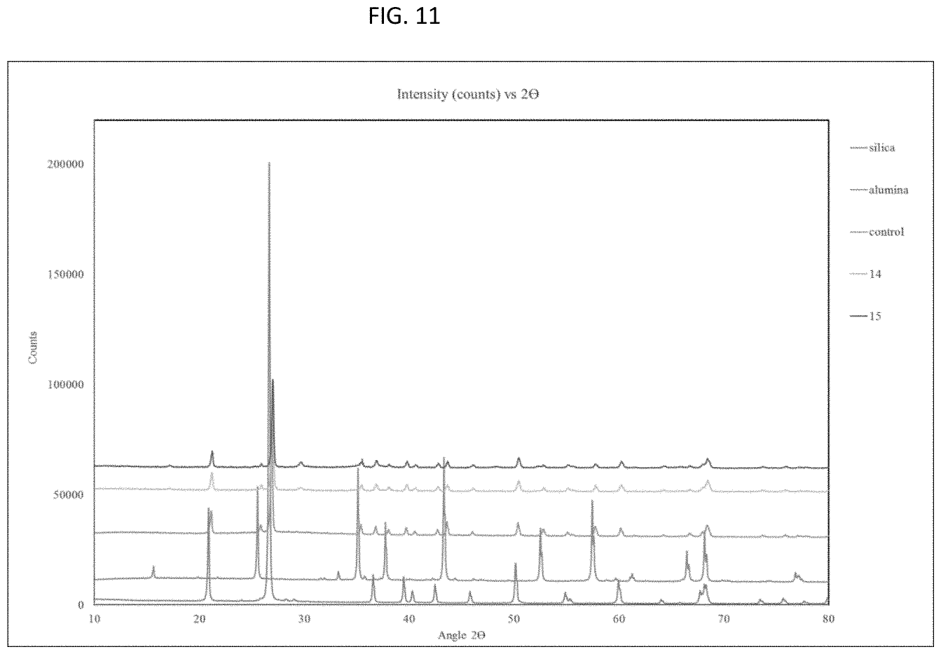

FIG. 11 is an overlay of XRD spectra of the precursor materials and samples with differing compositions of surfactant and blowing agent. The crystalline nature of starting materials as well as the samples both untreated and treated are clear from the overlay. The counts for samples in series, other than silica, have been offset by 10,000 counts each from the preceding for clarity. In addition, the y-axis maximum is set at 150,000 counts. The loss of peak at 2θ value of ˜15° in alumina indicates Al integration into the final aluminosilicate structure. In addition, there is strong possibility of existence of unreacted material in the product suggesting that all aluminum is not incorporated in the network. However, it is to be noted that any formation of the network structure is highly crystalline and ordered.

### NMR

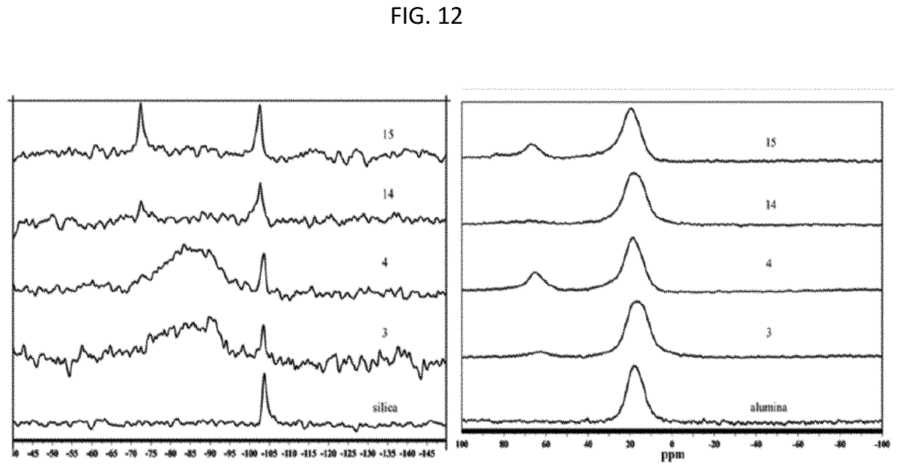

The FIG. 12 shows the ²⁹Si and ²⁷Al NMR spectra of precursor materials as well as alkali treated samples with surfactant and blowing agent incorporated. All spectra consist of a narrow peak at chemical shift of ˜−107 ppm in the ²⁹Si spectra consistent with the presence of unreacted silica. Correspondingly, all ²⁷Al spectra consists of a narrow peak at ˜12 ppm that indicate incomplete reaction. However, the appearance of broad peaks at ˜−85 ppm in ²⁹Si and at ˜65 ppm in ²⁷Al is due to wide bond angles of Si—O—Al10 as well as transient aluminum species11. Furthermore, the narrow line width in samples 14 and 15 when compared to the broad peaks of samples 3 and 4, specifies a unique type of Qₙ coordination i.e. Al(IV) in tetrahedral arrangement12-14 in the sample pair 14 and 15.

This additionally indicates formation of ordered zeolitic structure in samples with higher surfactant and blowing agent concentrations.

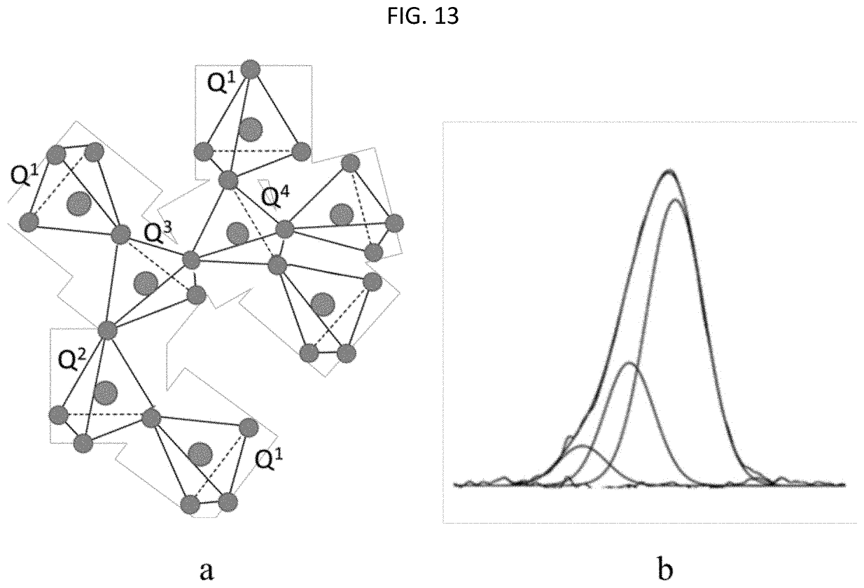

***In aluminosilicate networks, Qn coordination is an important form of nomenclature wherein the superscript ‘n’ indicates the bridging type oxygens linking the tetrahedral structure. The different types of possible Qn type coordination is shown in FIG. 13a. The peak broadening observed in ²⁷Si NMR is a combination of different coordinations and its constituents represent a particular type namely Q1, Q2, Q3 kind. The effective deconvoluted component peaks are shown in FIG. 1b.

### Effect of Stearic Acid, Hydrogen Peroxide and Sonication

Inherent porosity in control samples was generated by voids incorporated by simple water evaporation from the Al-Si matrix during curing at 100° C. However, the samples consisted of large air pockets on the upper surface as macroscopically observed post-curing. This is mainly due to the density differences between the reacted aluminosilicate and water. During curing, the water concentration increased at the upper portion of the samples and the Al-Si settled to the bottom to form a densely packed solid.

On addition of stearic acid to the Al-Si slurry, the voids were observed to be well distributed throughout the cured samples. In addition, the large void on the upper portion of the sample was eliminated. This indicated the key role played by stearic acid in keeping smaller bubbles from coalescing into larger ones.

The introduction of hydrogen peroxide into the Al-Si slurry was mainly to serve as a blowing agent. H₂O₂ is thermodynamically unstable and decomposes as follows

H₂O₂+OH⁻→HO₂⁻+H₂O

HO₂⁻+H₂O₂→O₂+H₂O+OH⁻

In some embodiments, the blowing agent comprises hydrogen peroxide (H₂O₂). In further embodiments, the blowing agent comprises 2-4 wt. % hydrogen peroxide in H₂O For example, the blowing agent may comprise hydrogen peroxide 3 wt. % in H₂O.

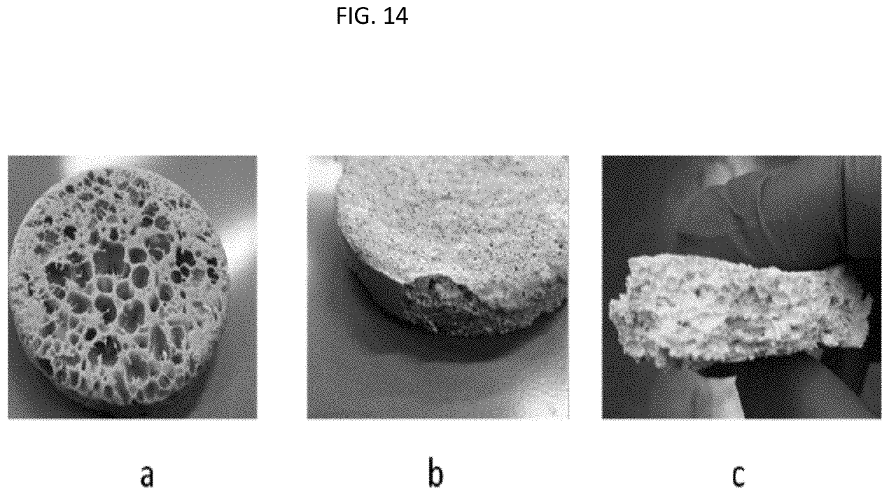

A probable synergistic effect due to the addition of both, stearic acid and hydrogen peroxide, resulted in a low-density foam with well distributed pores of relatively smaller cell sizes than the untreated control samples as shown in FIG. 14.

The FIG. 14 shows macroscopic improvements in samples due to stearic acid and hydrogen peroxide addition in comparison to untreated samples.

Sonication is a process of sound wave propagation through a solution in order to achieve homogeneity. The vibration of probe results in the occurrence of alternating low and high-pressure cycles in solution. Vacuum bubbles are created during low pressure cycle by high intensity ultrasonic waves. At a point when bubbles cannot absorb the ultrasound energy, they collapse during a high-pressure cycle. This process, termed as cavitation, aids in keeping the solution well dispersed.

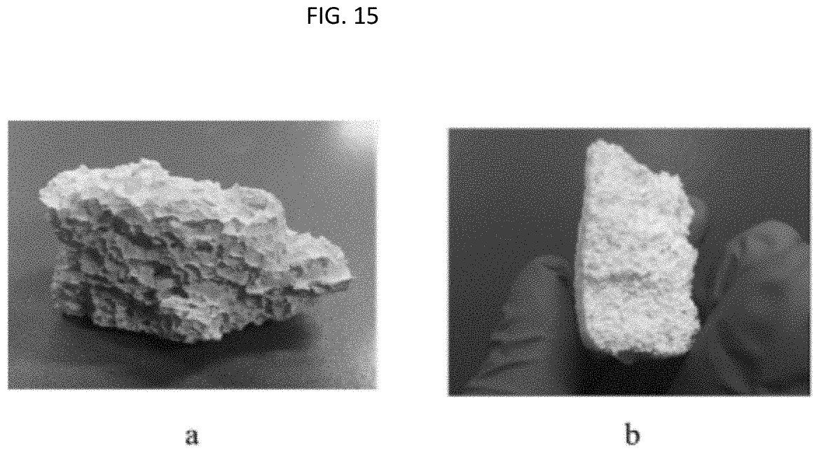

The sample in FIG. 15b appear more homogeneous with well distributed pores of smaller size than the sample in FIG. 15a confirming the positive effect of sonication.

### Porosity and Density

As received from the imaging of the scanned surfaces, the total volume of a 2.55 g (sample 14) was 6000 units corresponding to 6 cc and the density was determined to be 0.425 g/cc. Additionally, sample 15 had a density of 0.22 g/cc. The literature value density of a sodium aluminosilicate glass is 2.45 g/cc. Hence the reduction in density was a little over 5× (for sample 14) and 10× (sample 15) when compared to bulk Al-Si glasses.

### Flame Retardance

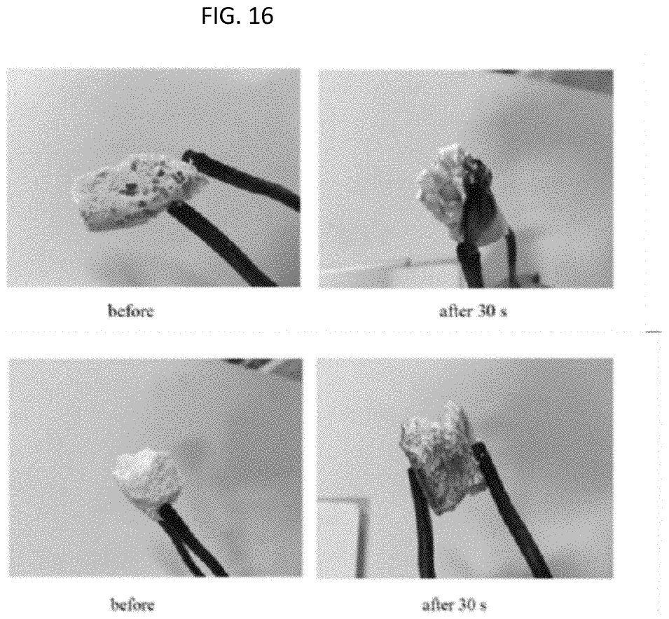

As seen in FIG. 16 (top), the control samples showed charring and blistering on exposure to the butane flame.

The bottom two images of FIG. 16, on the other hand, show behavior of sample 15 exposed to the flame. It showed no blistering with very little charring which is mostly due to the presence of stearic acid (organic compound) which decomposed at temperature of 232° C.

### Example 2

### Preparation of Aluminosilicate Foams

### Chemicals/Precursors

Metal oxides: Silicon (IV) oxide (SiO₂) 99.5% with ˜96% of particle sizes less than 10 μm from Alfa Aesar, Alumina (Al₂O₃) 99% fine powder with average particle sizes of 18.2 μm

Alkaline activators: sodium hydroxide 98% (NaOH) pellets

Blowing agent: Hydrogen peroxide (H₂O₂) 3 wt. % in H₂O

Surfactants: Saturated fatty acids {CH₃(CH₂)ₙCOOH} with varying ‘n’ that indicates varying carbon backbone length such as Lauric acid 99% (C₁₂H₂₄O₂), Palmitic acid (C₁₆H₃₂O₂), Stearic acid (C₁₈H₃₆O₂), Cerotic acid (C₂₆H₅₂O₂), etc.

Solvents: Distilled water (DW), ethanol or EtOH (C₂H₅OH) 70% or 200 proof

### Instruments/Accessories

Weighing balance, 250 mL thick walled Pyrex beaker, steel spatula, steel egg whisk, hotplate with stirrer, Teflon molds (3.2 in×0.6 in—diameter×height), Teflon rings for casting (2 in×0.5 in—diameter×height), Branson 450 cup-horn sonication unit, convection oven.

Post processing tools like hammer, saw, sanding facilities. Desiccator for sample storage.

### Procedure

### 10 M NaOH Solution

Weigh 40 g in a clean glass beaker.

Add DW until the meniscus reaches 100 mL mark. Drop in a teflon magnetic stirrer (1 inch) and stir. Heat will be released.

When fully dissolved, add additional water to ensure the meniscus is brought back to 100 mL mark (level drops due to NaOH pellet

dissolution).

Prepare solution well in advance (5 h prior).

### Surfactant solution (Stearic Acid, SA)

In a clean glass beaker, add 100 mL EtOH

Add 20 g SA and place on hot plate maintained at 75° C. Once solution is clear (takes about 10 min), drop temperature down to 55° C.

### Aluminosilicate (Al-Si) Slurry

Mix dry SiO₂ (30 g) and Al₂O₃ (8.5 g) in beaker.

Add 17 mL of 10M NaOH solution.

Add 3 to 5 mL of DW to facilitate stirring with spatula first (1 min) and then egg whisk (1-2 min)

Homogenize in sonicator at ‘constant’ duty cycle and ‘55 to 60%’ output control for 6 min (higher densities) and 8 min (for low density foams).

Once sonication is complete, gently stir with whisk and add H₂O₂ (varies from 0 to 12 g). Whisk for further homogenization (30 s).

Add SA solution (varies from 0 to 2.5 g) and whisk aggressively (2 min).

Using steel spatula, to facilitate pouring of slurry into Teflon molds and cure at 100° C.

Curing done for at least 24h (for density <1.0 g/cc) and at least 48 h (for density >1.0 g/cc).

Compositional variations (adjusting stearic acid and hydrogen peroxide contents) or using either without the other can be done if final density or mechanical rigidity of cured product has to be adjusted.

Surfactant and blowing agents weight changes are extremely sensitive and must be as accurate as possible to maintain consistency.

Sonication must ensure no heating of slurry as it may initiate premature decomposition of blowing agent as well as the chemical reaction between Si and Al.

Teflon molds must be dry and at room temperature. In addition, slurry must avoid making contact with mold walls to ensure minimal cracking in the final cured foam.

Samples must be stored in dry environment.

### Example 3

### Aluminosilicate Structures with GO Fillers (Preparation of an Exemplary Embodiment of the Invention)s

### Chemicals/Precursors

Metal oxides: Silicon (IV) oxide (SiO₂) 99.5% with ˜96% of particle sizes less than 10 μm from Alfa Aesar,

Alumina (Al₂O₃) 99% fine powder with average particle sizes of 18.2 μm

Alkaline activators: Sodium hydroxide 98% (NaOH) pellets

Solvents: Distilled water (DW), graphene oxide (GO) solution (concentration like 6 mg/mL, 16 mg/mL, etc.)

### Instruments/Accessories

Weighing balance, 250 mL thick walled Pyrex beaker, steel spatula, steel egg whisk, hotplate with stirrer, steel/copper (3.2 in×3 in—diameter×height), clamps, metal plates, parchment paper, convection oven.

Post processing tools e.g., hammer, saw, sanding facilities. Desiccator for sample storage.

### Procedure (Exemplary)

### Preparation of 10 M NaOH Solution

a) Weigh 40 g in a clean glass beaker.
b) Add DW until the meniscus reaches 100 mL mark. Drop in a Teflon magnetic stirrer (1 inch) and stir. Heat will be released.
c) When fully dissolved, add additional water to ensure the meniscus is brought back to 100 mL mark (level drops due to NaOH pellet dissolution).
d) Prepare solution well in advance (5 h prior).

### Aluminosilicate structures

a) Mix dry SiO2 (30 g) and Al2O3 (8.5 g) in beaker.
b) Add 17 mL of 10M NaOH solution and mix well with steel spatula.
c) Using spatula, to facilitate pouring of slurry into molds suggested and cure at 100° C.
d) Curing done for at least 48 h to 72 h.

For GO composite foams, add GO solution of concentration (at least 6 mg/mL) after step (b) in the above protocol under “aluminosilicate structures.”

### REFERENCES

All publications mentioned herein are incorporated by reference to the extent they support the present invention.

We claim:

1. A porous material comprising a mixture of two or more components chosen from earth abundant minerals, oxides, silicates, and chemically modified graphene (CMG), and optionally further comprising one or more blowing agents and/or one or more surfactants.

2. A porous material comprising two primary oxides and chemically modified graphene (CMG) and optionally comprising one or more earth abundant minerals.

3. The material according to claim 1, wherein said oxide is chosen from silicates, alumina, and transition metal oxides.

4. The material according to claim 2, wherein the primary oxides are present in an amount of about 20/80 wt. % to about 80/20 wt. %.

5. The material according to claim 4, said material further comprising about 1 wt. % or less of surfactants and/or blowing agents.

6. The material according to claim 1, wherein said material comprises less than about 1% chemically modified graphene (CMG) by weight.

7. The material according to claim 1, wherein said material comprises alumina silicate.

8. A porous material comprising one or more aluminosilicates; a mixture of two or more components chosen from earth abundant minerals, silicates, and oxides, and optionally further comprising one or more blowing agents and/or one or more surfactants.

9. The material according to claim 1, wherein said material is lightweight has a density of about 0.01-0.1 g/cc to about 5 g/cc.

10. The material according to claim 2, wherein said primary oxide is chosen from silicates, alumina, and transition metal oxides.

11. Shotcrete comprising said material of claim 1.

12. Concrete comprising said material of claim 1.

13. A 3D printing material wherein said 3D printing material comprises the material of claim 1, sodium perborate, and water.

14. An insulating material comprising said material of claim 1.

15. An anti-corrosion material comprising said material of claim 1.

16. A method of insulating a surface comprising applying the insulating material according to claim 15 to said surface.

17. A method of protecting a surface from corrosion comprising applying the anti-corrosion material according to claim 16 to said surface.

18. The material according to claim 1, wherein said CMG is graphene oxide (GO), reduced graphene oxide (rGO), or cation crosslinked GO.

19. The material according claim 3, wherein transition metal oxide is chosen from titanium oxide, iron oxide (Fe²⁺ or, Fe³⁺), Fe₃O₄, zirconia, hafnia, vanadium oxide (II-V), ruthenium oxide, copper oxide, and wherein said silicate is chosen from calcium silicate, magnesium silicate, and aluminosilicate.

20. The porous material according to claim 8, wherein said silicate is calcium silicates.
